(19) United States
(12) Patent Application Publication
(10) Pub. No.: US 2008/0142668 A1
(43) Pub. Date: Jun. 19, 2008

(54) Book Reading Aid

(76) Inventor: Robert Francis Rickards, Exmouth (GB)

Correspondence Address: Law Office Of Ira S Dorman, 330 Roberts Street, Suite 200, East Hartford, CT, 06108, US

(21) Appl. No.: 10/585,266

(22) PCT Filed: Jan. 4, 2005
(86) PCT No.: PCT/GB05/00003

§ 371 Date: Jul. 5, 2006

(30) Foreign Application Priority Data
Jan. 5, 2004 (GB) 0400076.6

(51) Int. Cl. A47B 97/04; B42D 17/00; A47B 97/00

(52) U.S. Cl. 248/451; 281/45; 248/460; 248/454

(57) ABSTRACT

A device for facilitating the reading of a book by holding its pages in an open position, includes an elongate member formed of telescopically-engaged inner and outer elements 107 and 108. The outer element 108 has a projecting platform 14 to support the cover of an open book B, and respective inwardly-directed end-pieces 101 and 102 are pivotally connected to the respective elements 107 and 108, with inwardly-directed finger portions 30 that hold the pages of the book by means of coil springs 203. A support leg 40 is slidably engaged with the outer element 108 to support the rear of the book while resting on its lower edge. The support leg can be angularly adjusted about an axis which is substantially parallel to the outer element 108 and can be rotated about an axis which is substantially perpendicular to the outer element. The leg 40 may have an inner core which is telescopically engaged within a non-slip outer cover.

### TECHNICAL FIELD OF THE INVENTION

This invention relates to a device for facilitating the reading of a book.

### BACKGROUND

Books which have simple bindings, particularly paper-back books, do not open flat, especially when new, and tend to close while being read. This is a nuisance because either the book has to be held open when reading or some means have to found to prevent the book from closing. Readers resort to various devices for achieving this end, such as elastic bands, or weights of one sort or another. More sophisticated devices exist such as small lecterns with paper retainers, but these can be inconvenient for personal users.

WO 03 057 498 A1 discloses a device which includes an elongate telescopic element for supporting the cover of an open book with spring-loaded end pieces to hold the open pages. Whilst this device is capable of firmly holding books of various sizes without damaging the pages the user is still required to hold the book whilst reading in bed for example.

It is an object of the present invention to provide an improved device for facilitating the reading of a book which is more versatile than existing devices whilst still being easy to operate and capable of firmly holding books of varying sizes without risk of damaging the book.

### SUMMARY OF THE INVENTION

According to the present invention, a device for facilitating the reading of a book has a support leg which projects from an elongate member substantially perpendicular to a platform to angularly support the book while resting on its lower edge.

More particularly there is provided a device for facilitating the reading of a book by holding its pages in an open position, said device including an elongate member for spanning the cover of an open book, and two end-pieces which include finger portions directed inwardly towards each other at opposite ends of the elongate member, the elongate member including inner and outer telescopically-engaged elements which carry the respective end pieces whereby the distance between the end-pieces can be adjusted, and the outer element carries a platform which projects at opposite sides of said elongate member to support the cover of the book, the end pieces being formed as separate components which have pivotal connections with the elongate member, and each of said end-pieces is provided with a respective spring element for urging the respective finger portion towards the elongate member to grip the pages,
characterised in that
   a support leg is slidably engaged with the outer element to project substantially perpendicularly away from the platform.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a general view of a book holder in accordance with the invention;

FIG. 2 is a side view of the book holder being used to hold a book;

FIG. 3 is an end view of the book holder being used to support the book on a horizontal surface;

FIG. 4 shows the support leg of the book holder in exploded detail;

FIG. 5 is an end view of the inner core of the support leg;

FIG. 6 is an end view of the outer cover of the support leg;

FIG. 7 shows a hinge component of the leg in side view;

FIG. 8 is a transverse section through a slider component by which the leg is attached;

FIG. 9 shows another possible use of the book holder, secured to a computer monitor by means of a mounting sleeve; and

FIG. 10 shows the mounting sleeve in end view.

### DETAILED DESCRIPTION OF THE DRAWINGS

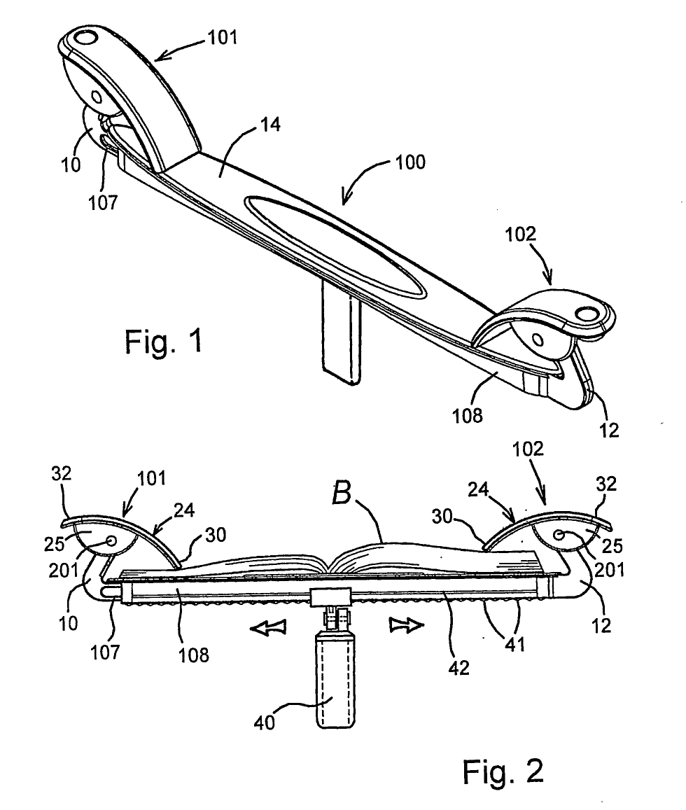

Referring firstly to FIG. 1, the book holder has an elongate member 100 which terminates in curved end-pieces 101, 102. The member 100 has upstanding arms 10 and 12 at opposite ends, which are angularly inclined towards each other, and includes a tubular outer section 108 of generally rectangular cross-section and an inner section 107 which can be moved telescopically within the outer section so that the distance between the arms 10 and 12 can be continuously varied for use with books of different sizes. A platform 14 of substantially elliptical outline is mounted on the upper face of the outer section 108 projecting at opposite sides of the elongate member.

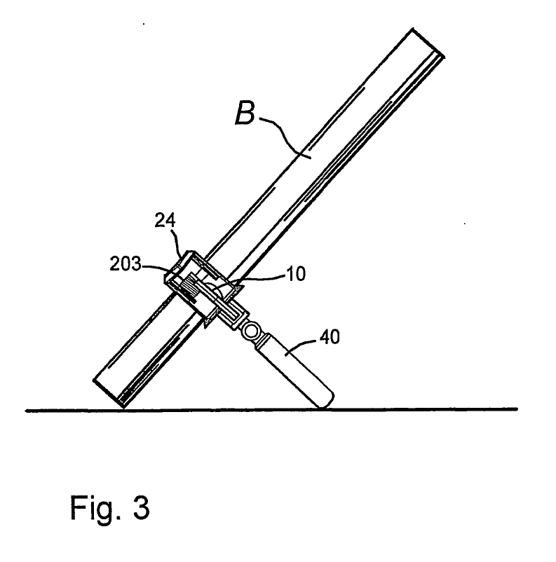

Referring to FIG. 2, the end-pieces 101 and 102 are each made of a substantially rigid material having a curved part 24 in the shape of a planar strip which has been arcuately curved in one dimension. A pair of spaced flanges 25 depend from the underside of the curved part 24 on opposite sides of the respective arm 10, 12 to which the flanges are secured by means of a pivot pin 201. One end of each curved part 24 forms an inwardly-directed finger portion 30 while the opposite end projects on the opposite side of the pivot pin 201 forming a lever portion 32. As can be seen in FIG. 3, a coil spring 203 is carried on each of the pins 201 with one end bearing against curved part 24 and the other end bearing against the respective arm 10, 12 so that the finger portion 30 is urged towards the platform 14. The tip of each finger portion 30 is substantially straight in a direction which extends substantially parallel to the axis of the pivot pin 201, but in side elevation (FIG. 2) the tip of the finger is formed with a smooth curve. When the device is used to hold the pages of an open book B the spine of the book is firmly supported by the platform 14 while the springs 203 press the ends of the fingers 30 against the open pages.

Continuing to refer to FIG. 2, a support leg 40 is slidably mounted on the outer section 108 of the elongate member 100 such that it can be positioned anywhere along its length, as indicated by the solid arrows. The bottom face of the outer section 108, opposite to the platform 14, is formed with a series of shallow transverse ridges 41 while opposite side faces are each formed with a longitudinal rib 42. The purpose of these features will be explained below. Since the leg 40 projects substantially perpendicularly away from the platform 14, if the bottom edge of the book B rests on a surface as in FIG. 3, the leg 40 can be used to support the book in an inclined position, as shown. Adjustment of the inclination of the book may be achieved by moving the book holder up or down the book. A higher position will reduce the angle whereas a lower position will result in a steeper angle. Furthermore, by sliding the leg 40 along the elongate member 100 it is possible to balance a book of any size to rest in a stable condition on any surface, whether it be a flat surface such as a desk or an uneven surface such as a bed cover.

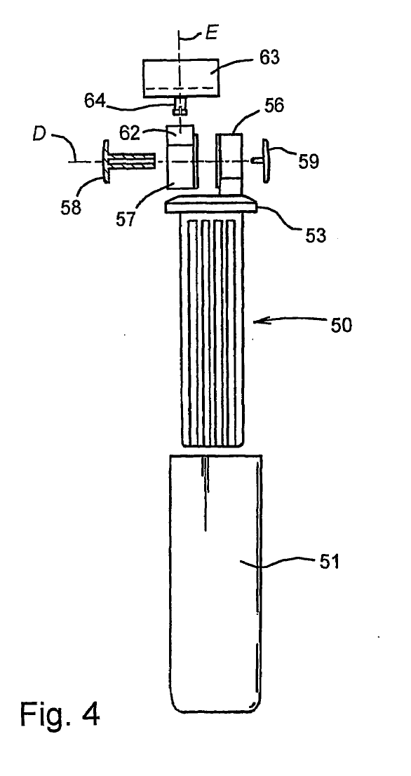

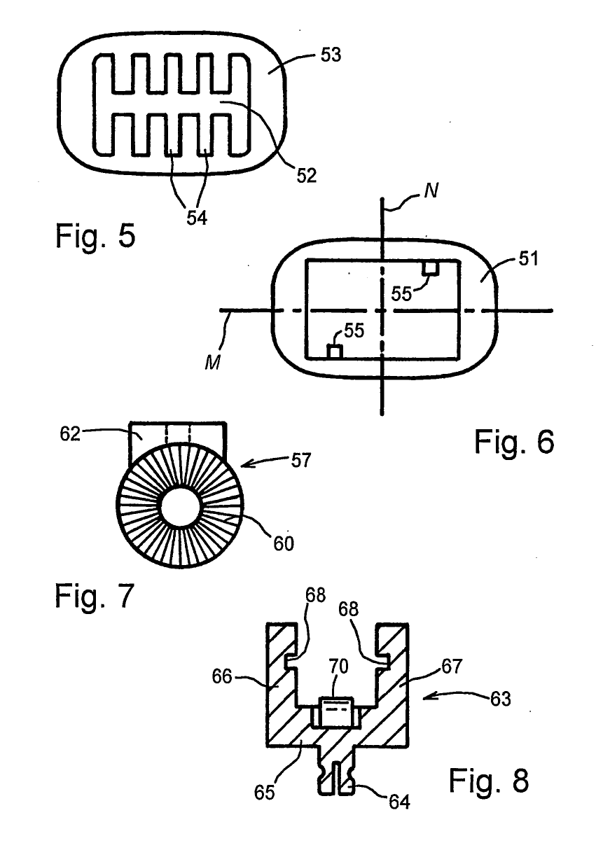

The detailed structure of the leg 40 is revealed in FIGS. 4 to 8. The leg includes a moulded core 50 with an elongate moulded cover 51 which may be formed of or coated with a friction material. As best seen in FIG. 5, the core 50 has a flat tongue 52 projecting from a top wall 53. The opposite faces of the tongue 52 carry parallel longitudinal ribs 54 which frictionally engage the internal surface of the cover 51, which is shown in top view in FIG. 6. Additional projections 55 may be formed inside the cover 1 to guide the cover as it slides telescopically on the core 50 and/or to provide an improved grip. In end view, the cover 51 has a major axis M and a minor axis N. The bottom end of the cover is straight with rounded corners (see FIGS. 3 and 4). The top wall 53 carries a hinge projection 56 (FIG. 4) to co-operate with a hinge component 57. A two-part hinge pin 58, 59 pivotally connects the two hinge sections 56 and 57 so that the leg may rotate about a pivot axis D which is parallel to the major axis M. The opposing faces of the hinge sections 56 and 57 are provided with co-operating shallow radial ribs 60, shown in FIG. 7, so that the leg 40 will normally be retained in any angular position to which it is adjusted. This pivotal arrangement therefore provides a second way in which the angle of the book may be changed if desired. A third way of adjusting the angle, which may be particularly useful for large or heavy books which are best supported at a higher level it to slide the cover 51 over the core 50 to telescopically extend the leg.

As can be seen in FIG. 4, the hinge component 57 includes a block 62 for connection with a slider 63. The slider carries a moulded pin 64 which is sprung into an aperture in the block 62 such that the leg 40 may be rotated about a second axis E which is perpendicular to the first pivot axis D and parallel to the longitudinal direction of the leg. This enables the direction of the leg to be adjusted to support a book with greater stability on an uneven surface, e.g. when reading in bed. FIG. 8 shows the slider 63 in transverse section on the pivot axis E. The slider includes a bottom wall 65 with a pair of upstanding side walls 66 and 67 with opposing grooves 68 to receive the ribs 42 when the slider is slid onto the outer section 108 of the elongate member 100. The bottom of the slider is provided with a spring finger 70 or a moulded projection which engages the ridges 41 to retain the slider in any adjusted position.

When the book holder is not in use the leg 40 can be removed by sliding it off the outer section 108. Alternatively, the leg can be pivoted about the axis D and rotated about axis E to lie parallel to the elongate member 100.

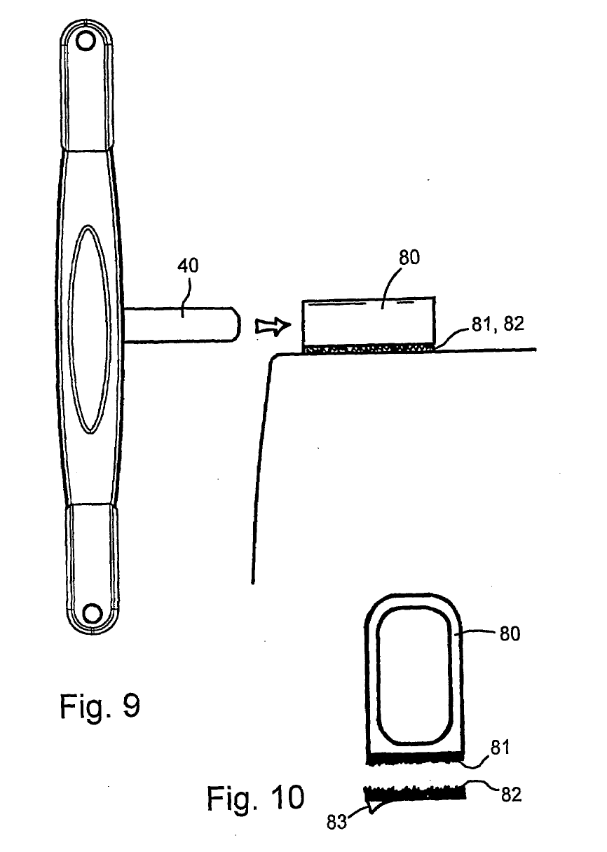

A further use of the book holder is shown in FIGS. 9 and 10. A sleeve 80 adapted to receive the leg 40 as a push fit can be mounted on a computer monitor, a printer or the like by means of releasable pads of hook and loop material 81 and 82. One of the pads is bonded to the sleeve 80 while the other is secured to the monitor etc. by a layer of pressure-sensitive adhesive, which may be protected by a peelable backing 83 prior to use. When the leg 40 is inserted into the sleeve 80 the book holder can be used to hold a book or, if desired, one or more printed sheets of paper. The position of the holder can be adjusted by rotating the leg about the axes D and E and moving the slider 63 along the outer section 108.

The top wall 53 of the core 50 may, alternatively, be connected to the slider 63 by means of a ball-and-socket or other universal joint to provide equivalent pivotal movements about the mutually perpendicular axes D and E.

It will be appreciated that the features disclosed herein may be present in any feasible combination. Whilst the above description lays emphasis on those areas which, in combination, are believed to be new, protection is claimed for any inventive combination of the features disclosed herein.

1. A device for facilitating the reading of a book by holding its pages in an open position, said device including an elongate member (100) for spanning the cover of an open book (B), and two end-pieces (101, 102) which include finger portions (30) directed inwardly towards each other at opposite ends of the elongate member, wherein each of said end-pieces (101, 102) is provided with spring means (203) for urging the respective finger portion towards the elongate member to grip the pages, and a support leg (40) projects from the elongate member (100) to angularly support the book (B) while resting on its lower edge,
characterised in that
the elongate member includes a platform (14) which projects at opposite sides of said elongate member (100) to support the cover of the book, and said support leg (40) is of elongate shape with one end joined to the elongate member by pivotal connection means (56-59) such that the support leg is angularly adjustable relative to the platform (14).

2. A device according to claim 1 in which the support leg (40) is slidably engaged with the elongate member (100).

3. A device according to claim 2 in which the elongate member (100) includes inner and outer telescopically-engaged elements (107, 108) which carry the respective end pieces (101, 102) whereby the distance between the end-pieces can be adjusted, and the support leg (40) is slidably engaged with the outer telescopically-engaged element (108).

4. A device according to claim 1 in which said pivotal connection means (56-59) allows the support leg (40) to be angularly adjusted about a rotational axis (D) which is substantially parallel to the longitudinal direction of the elongate member (100).

5. A device according to claim 4 in which said pivotal connection means includes a hinge projection (56) on the support leg (40) which is pivotally connected to a hinge component (57) by means of a hinge pin (58, 59).

6. A device according to claim 1 in which the support leg (40) is rotatably connected to the elongate member (100) for rotation about an axis (E) which is substantially perpendicular to the longitudinal direction of the elongate member (100).

7. A device according to claim 6 in which the support leg (40) is rotatably connected to a slider (63) which is slidably engaged with the elongate member (100).

8. A device according to claim 1 in which the support leg (40) comprises a plurality of telescopically-engaged sections (50, 51) whereby the support leg (40) may be telescopically extended.

9. A device according to claim 1 including a mounting sleeve (80) which is arranged to receive the support leg (40) as a push fit and which is provided with means (81, 82) for releasably attaching the sleeve to a surface.

10. A device according to claim 1 in which the support leg has an opposite end (51) from the elongate element (100) which is formed of or coated with a friction material.

11. A device according to claim 1 in which the end pieces (101, 102) are formed as separate components which have pivotal connections (25, 201) with the elongate member (100).
